(19) United States
(12) Patent Application Publication
(10) Pub. No.: US 2019/0042991 A1
(43) Pub. Date: Feb. 7, 2019

(54) RESOURCE PHYSICAL POSITIONING PLANNING TOOL

(71) Applicant: Novitex Enterprise Solutions, Inc., Stamford, CT (US)

(72) Inventor: Thomas CHENG, Queens, NY (US)

(21) Appl. No.: 16/146,765

(22) Filed: Sep. 28, 2018

Related U.S. Application Data
(63) Continuation of application No. 14/526,697, filed on Oct. 29, 2014.

(51) Int. Cl. G06Q 10/06

(52) U.S. Cl. CPC G06Q 10/06313; G06Q 10/0639

(57) ABSTRACT

A method, system and computer program product for resource physical positioning planning is provided. The method includes establishing a mapping of different computing resources and corresponding physical locations of a computing environment. Access requests that are issued to the different computing resources by different client computers communicatively coupled to the computing resources over a network disposed within the environment are monitored. Utilization of each of the computing resources by the client computing devices is computed so as to determine for a selected computing resource, one or more of the client computing devices most often requesting access to the selected computing resource. Finally, a positioning rule is applied to the selected computing resource and the one or more of the client computing devices and an optimal position is displayed for the selected computing resource according to the positioning rule.

### CROSS-REFERENCE TO RELATED APPLICATION

This application claims the benefit of U.S. patent application Ser. No. 14/526,697, filed on Oct. 29, 2014, entitled “RESOURCE PHYSICAL POSITIONING PLANNING TOOL,” the disclosure of which is expressly incorporated by reference herein in its entirety.

### BACKGROUND OF THE INVENTION

### Field of the Invention

The present invention relates to auditing the resources of a computing environment and the re-organization of audited resources in a computing environment, and more particularly to resource physical position planning in a computing environment.

### Description of the Related Art

The modern computing environment typically includes one or more physical host computing devices providing one or more servers supporting the operation of one or more applications for use by different end users over a computer communications network. The physical resources of the modern computing environment thus include not only physical servers, desktop and mobile computing clients and network infrastructure including different switches and routers, but also ancillary devices including local physical storage devices, scanners, printers and display units. Generally, the physical servers and network infrastructure are physically positioned in a few select locations within the office environment—typically a “server closet” or for larger deployments, a “server room” or “data center”. For each ancillary device, however, positioning oftentimes is random and largely dependent upon the availability of physical floor space or counter space to accommodate the ancillary device.

Of all of the ancillary devices that are common to the modern computing environment, the printer is most often utilized by most if not all end users of the computing environment. Managing the acquisition, positioning and utilization of a fleet of printers, however, for most information technologies is more of an art than a science.

More accurately, little strategy exists for most office environments in the acquisition, positioning and utilization of a printer. Instead, the decision to acquire a new printer oftentimes is an ad hoc decision driven by the need to replace an existing, but failing printer, or the desire by an individual in the office environment to acquire a new printer for use by the individual primarily. For a small computing environment of only a few end users, the lack of strategy in acquiring, positioning and utilizing a printer is of little consequence. However, for the larger computing environment, the sort of wastefulness associated with the mismanagement of a printer fleet cannot be tolerated.

### BRIEF SUMMARY OF THE INVENTION

Embodiments of the present invention address deficiencies of the art in respect to resource physical positioning in a computing environment and provide a novel and non-obvious method, system and computer program product for resource physical positioning planning. In an embodiment of the invention, a resource physical positioning planning method includes establishing a mapping of different computing resources, such as different printers, and corresponding physical locations of a computing environment. Thereafter, access requests that are issued to the different computing resources by different client computers communicatively coupled to the computing resources over a computer communications network disposed within the computing environment are monitored. Utilization of each of the computing resources by the client computing devices is computed so as to determine for a selected computing resource, one or more of the client computing devices most often requesting access to the selected computing resource. Finally, a positioning rule is applied to the selected computing resource and the client computing devices and an optimal position is displayed for the selected computing resource according to the positioning rule.

In one aspect of the embodiment, the positioning rule is a rule that requires a maximum utilization ratio of client computers to a computing resource. In another aspect of the embodiment, the positioning rule is a rule that requires a maximum distance permitted between a computing resource and a client computer determined to frequently utilize the computing resource. In yet another aspect of the embodiment, during the establishment of the mapping, a replacement device is identified for a mapped one of the computing resources and the replacement device is displayed in the computing system. For example, the replacement device can have a power consumption characteristic that differs from the mapped one of the computing resources.

In another embodiment of the invention, a data processing system is configured for resource physical positioning planning. The system includes a host computing system that includes memory and at least one processor. The system also includes persistent storage disposed within the host computing system. The persistent storage stores a mapping of different computing resources and corresponding physical locations of a computing environment. Finally, the system includes a resource physical positioning planning module executing in the memory of the host computing system.

The module includes program code enabled upon execution in the memory to monitor access requests issued to the different computing resources by different client computers communicatively coupled to the computing resources over a computer communications network disposed within the computing environment. The program code also is enabled to compute utilization of each of the computing resources by the client computing devices so as to determine for a selected one of the computing resources, one or more of the client computing devices most often requesting access to the selected one of the computing resources. The program code further is enabled to apply by a processor of the computing system a positioning rule to the selected one of the computing resources and the one or more of the client computing devices, the positioning rule specifying an optimal position for a computing resource based upon a known utilization of the computing resource by one or more client computing devices. Finally, the program code is enabled to display in the host computing system an optimal position for the selected one of the computing resources according to the positioning rule.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for resource physical positioning planning;

FIG. 2 is a schematic illustration of a data processing system configured for resource physical positioning planning; and,

FIG. 3 is a flow chart illustrating a process for resource physical positioning planning.

### DETAILED DESCRIPTION OF THE INVENTION

Embodiments of the invention provide for resource physical positioning planning. In accordance with an embodiment of the invention, a mapping can be established in persistent storage of a computing system between different computing resources, such as different printers, and different physical locations with a computing environment. Thereafter, access to the computing resources can be monitored and individual records written to memory of the computing system, each of the records including an identifier of a client computing device requesting access to a corresponding one of the computing resources. The records then are processed to compute a volume of requests for each of the computing resources and a corresponding utilization by each of the client computing devices so as to determine which of the computing devices are most often used by different ones of the client computing devices. One or more positioning rules subsequently can be loaded into the memory of the computing system and applied to the computed utilization to produce a recommended change in location within the computing environment of at least one of the computing resources so as to optimally position the computing resources closest to corresponding ones of the client computing devices most often utilizing the computing resources.

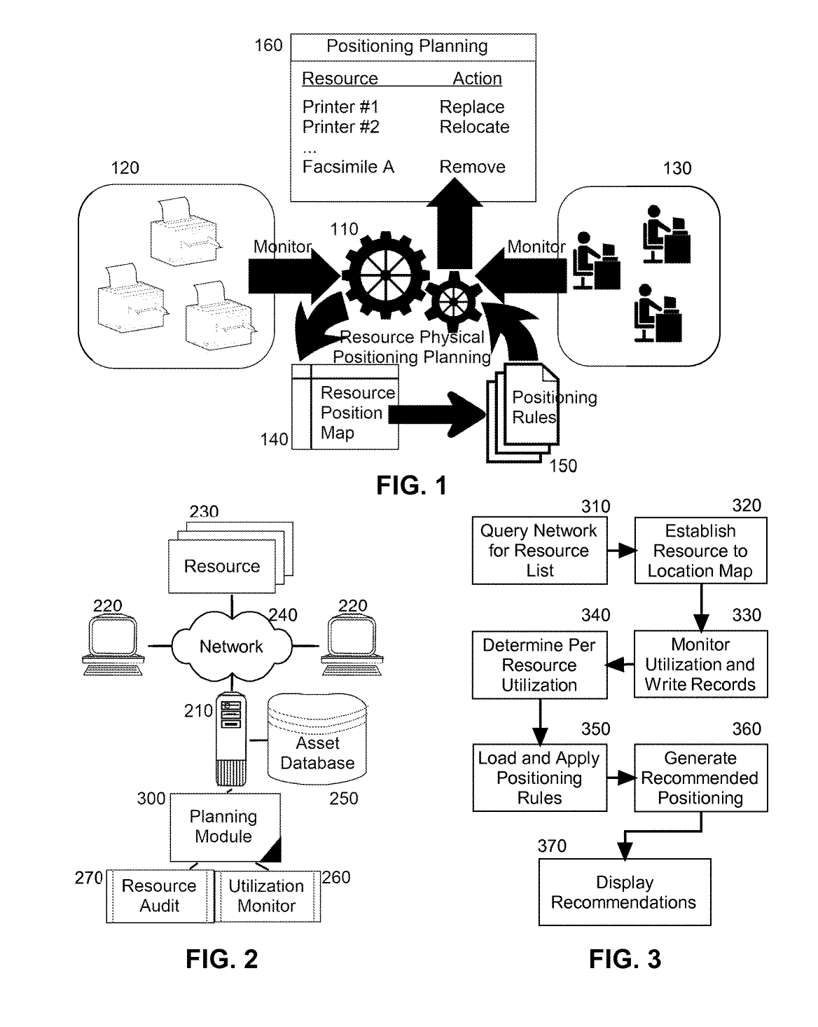

In further illustration, FIG. 1 is a pictorial illustration of a process for resource physical positioning planning. As shown in FIG. 1, resource physical positioning planning logic 110 catalogs one or more computing resources 120 of a computing environment, for instance one or more printers, facsimile devices, scanning devices and the like. The cataloging performed by the resource physical positioning planning logic 110 includes a position of each of the computing resources 120 within the computing environment. The resource physical positioning planning logic 110 subsequently can establish a resource position map 140 in which the position of each of the resources 120 within the computing environment can be persisted. Thereafter, the resource physical positioning planning logic 110 monitors requests to access the resources 120 issued by different client computing devices 130 (associated with different individuals) within the computing environment.

Based upon the monitored requests, the resource physical positioning planning logic 110 computes a frequency of utilization of each of the resources 120 by respectively different ones of the client computing devices 130. Utilizing the computed frequency of utilization, one or more positioning rules 150 are applied to determine a positioning action to be taken, if any, with respect to each of the resources 120. For instance, the positioning rules 150 might specify that a particular one of the resources 120 is to be positioned within a maximum distance from a most frequent utilizing one of the client computing devices 130. Another of the positioning rules 150 might specify that a particular one of the resources 120 is to be replaced with a more efficient or more rapidly performing device. In any event, the outcome of the application of the positioning rules 150 can be presented by the resource physical positioning planning logic 110 in a corresponding display 160.

The process described in connection with FIG. 1 can be implemented within a data processing system. In further illustration, FIG. 2 schematically shows a data processing system configured for resource physical positioning planning. The system includes a host computing system 210 that includes one or more computers, each with memory and at least one processor. The host computing system 210 can be coupled to different client computing devices 220 over computer communications network 240. Each of the client computing devices 220 in turn can access one or more different computing resources 230 also coupled to the host computing system 210 over the computer communications network 240.

A planning module 300 can include program code enabled to execute in the memory of the host computing system 210. The planning module 300 can include program code performing resource auditing 250 and utilization monitoring 260. The resource auditing 250 can act to identify the resources 230 accessed by the different client computing devices 220 and to establish within an asset database 250, a physical position of each of the resources 230 within a computing environment. The resource auditing 250 also can identify different ones of the computing resources 250 that are replaceable with a replacement resource, such as a resource demonstrating a more efficient power consumption characteristic. The utilization monitoring 260 in turn can monitor requests to access the resources 230 by the client computing devices 220 and the extent of each request, such as a number of pages requested to print at a particular printer by a particular one of the client computing devices 220.

The program code of the planning module 300 is further enabled upon execution in the memory of the host computing system 210 to determine a frequency of utilization of each of the resources 230 by different ones of the client computing devices 220, and to apply one or more positioning rules to determine an optimal physical location of each of the resources 230 within the computing environment. The rules can include, by way of example, a rule that requires a maximum utilization ratio of client computers to a computing resource, a maximum distance permitted between a computing resource and a client computer determined to frequently utilize the computing resource. Thereafter, the program code is enabled to display the resulting recommendations as to the positioning of the computing resources 230 within the computing environment in the host computing system 210.

In yet further illustration of the operation of the planning module 300, FIG. 3 is a flow chart illustrating a process for resource physical positioning planning. Beginning in block 310, a computer communications network deployed in a computing environment can be queried to identify different computing resources accessed by different client computers communicatively coupled to the computing resources over the computer communications network. In block 320, a computing resource to location map can be established in persistent storage for the computing environment, and optionally, one or more replacement devices can be identified for corresponding one or more of the identified different computing resources. Thereafter, in block 330 identified computing resources can be monitored and access requests by the different client computing devices to the computing resources can be recorded in memory.

In block 340, a per resource utilization by the different client computers can be computed. Based upon the utilization, in block 350 one or more positioning rules can be applied so as to determine in block 360 an optimal position of each of the computing resources based upon the frequency of utilization by each of the client computing devices, and the location of the client computing devices. Finally, in block 370 the determined recommendations for the optimal positioning of the computing resources can be displayed.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

What is claimed is:

1. A method for managing locations of a plurality of computing systems based on resource use, comprising:
generating a first map comprising a location of the plurality of computing systems and a location of a plurality of client computing systems in a spatial environment;
monitoring access requests issued to each of the plurality of computing systems via a network transmission from the plurality of client computing systems;
determining the resource use for each of the plurality of computing systems based on the monitored access requests; and
generating a second map of the spatial environment identifying a new location for a first computing system of the plurality of computing systems, a resource use at the new location being less than the resource use at a previous location in the first map.

2. The method of claim 1, wherein each of the plurality of computing systems is a printer.

3. The method of claim 1, further comprising determining the new location for the first computing system based on a positioning function.

4. The method of claim 1, further comprising identifying, based on the determined resource use, a replacement computing systems for a second computing system of the plurality of computing systems, wherein a power use of the replacement computing system being less than the power use of the second computing system.

5. The method of claim 4, wherein the second map further identifies a location for the replacement computing system.

6. An apparatus for managing locations of a plurality of computing systems based on resource use, the apparatus comprising:
a memory; and
at least one processor coupled to the memory, the at least one processor configured:
to generate a first map comprising a location of the plurality of computing systems and a location of a plurality of client computing systems in a spatial environment;
to monitor access requests issued to each of the plurality of computing systems via a network transmission from the plurality of client computing systems;
to determine the resource use for each of the plurality of computing systems based on the monitored access requests; and
to generate a second map of the spatial environment identifying a new location for a first computing system of the plurality of computing systems, a resource use at the new location being less than the resource use at a previous location in the first map.

7. The apparatus of claim 6, wherein each of the plurality of computing systems is a printer.

8. The apparatus of claim 6, wherein the at least one processor is further configured to determine the new location for the first computing system based on a positioning function.

9. The apparatus of claim 6, wherein:
the at least one processor is further configured to identify, based on the determined resource use, a replacement computing systems for a second computing system of the plurality of computing systems, and
a power use of the replacement computing system being less than the power use of the second computing system.

10. The apparatus of claim 9, wherein the second map further identifies a location for the replacement computing system.

11. A non-transitory computer-readable medium having program code recorded thereon for managing locations of a plurality of computing systems based on resource use, the program code executed by a processor and comprising:
program code to generate a first map comprising a location of the plurality of computing systems and a location of a plurality of client computing systems in a spatial environment;
program code to monitor access requests issued to each of the plurality of computing systems via a network transmission from the plurality of client computing systems;
program code to determine the resource use for each of the plurality of computing systems based on the monitored access requests; and
program code to generate a second map of the spatial environment identifying a new location for a first computing system of the plurality of computing systems, a resource use at the new location being less than the resource use at a previous location in the first map.

12. The non-transitory computer-readable medium of claim 11, wherein each of the plurality of computing systems is a printer.

13. The non-transitory computer-readable medium of claim 11, wherein the program code further comprising program code to determine the new location for the first computing system based on a positioning function.

14. The non-transitory computer-readable medium of claim 11, wherein the program code further comprising program code to identify, based on the determined resource use, a replacement computing systems for a second computing system of the plurality of computing systems, a power use of the replacement computing system being less than the power use of the second computing system.

15. The non-transitory computer-readable medium of claim 14, wherein the second map further identifies a location for the replacement computing system.
